(19) United States
(12) Patent Application Publication
(10) Pub. No.: US 2015/0198114 A1
(43) Pub. Date: Jul. 16, 2015

(54) PISTON FOR AN INTERNAL COMBUSTION ENGINE

(71) Applicants: BRP-POWERTRAIN GMBH & CO.KG, Gunskirchen (DE); ASSO WERKE S.R.L., Calcinaia-Fornacette (IT)

(72) Inventors: Gunther Zauner, St. Willibald (AT); Michael Gumpesberger, Haid (AT); Dimitri Anguillesi, Vicopisano (IT)

(21) Appl. No.: 14/419,028

(22) PCT Filed: Jul. 25, 2013
(86) PCT No.: PCT/EP2013/065769

§ 371 Date: Feb. 2, 2015

Related U.S. Application Data
(60) Provisional application No. 61/677,669, filed on Jul. 31, 2012.

(51) Int. Cl. F02F 3/24; F02M 61/14; F02B 75/02; F02F 3/00; F16J 9/24

(52) U.S. Cl. CPC F02F 3/24; F02F 3/0069; F02F 3/0084; F16J 9/24; F02B 75/02; F02M 61/14; F02B 2075/025

(57) ABSTRACT

A piston for a two-stroke internal combustion engine has a crown and a skirt extending from the crown. The skirt defines a reciprocation axis of the piston. A circumferential piston groove is defined in the crown. An annular ring carrier is disposed in the piston groove. A circumferential carrier groove is defined in the ring carrier, the carrier groove being concentric with the piston groove. A retainer is disposed in the carrier groove. The retainer extends at least in a radial direction of the piston into the ring carrier. The carrier groove is adapted to receive a piston ring and the retainer is adapted to prevent rotational motion of the piston ring in the carrier groove, the rotational motion being about the reciprocation axis. Two-stroke internal combustion engines are also disclosed.

### CROSS-REFERENCE

The present application claims priority to U.S. Provisional Patent Application No. 61/677,669 filed on Jul. 31, 2012, the entirety of which is incorporated herein by reference.

### FIELD OF THE INVENTION

The present invention relates to pistons for internal combustion engines.

### BACKGROUND

Vehicle and engine manufacturers generally try to reduce the weight of the various components of the vehicle, including the engine, in order to improve energy efficiency. In many engines, especially two-stroke engines, traditional steel pistons have been replaced with aluminum pistons. In addition to being lighter in weight, aluminum pistons are also less expensive and provide good heat conductivity characteristics.

A number of different factors can contribute to high temperatures of the pistons. For example, engine with high power output tend to generate more heat. As another example, combustion of lean air-fuel mixtures also results in higher temperatures. In carbureted two-stroke engines, fuel mixed with air flowing in the crankcase can absorb some of the heat from the pistons. However, some two-stroke engines now employ direct fuel injection technology where the fuel is injected directly in the combustion chambers. As a result, fuel no longer flows in the crankcase and cannot aid in absorbing heat from the pistons, leading to the pistons getting hotter. Currently, under full load operating conditions in some two-stroke engines, for example, a 100 hp 800 cc engine, the temperature can exceed 420° C. at the piston crown and 300° C. at the piston ring. It is therefore desirable to have good heat conductivity in pistons, and pistons made of aluminum or aluminum alloys are thus preferable to steel pistons.

One of the disadvantages of aluminum pistons is that they are less structurally resistant to high temperatures than steel pistons. The high temperatures reached in aluminum pistons can sometimes result in structural weakening of the aluminum in the area of the piston ring groove. Excessive wear, especially on the lower side of the groove, can lead to effects such as knocking of the ring under combustion pressure, increased blow-by, loss of power, etc. Furthermore, high temperatures in aluminum pistons could also sometimes cause plastic deformation of the pin bores.

Factors other than heat are also known to cause excessive wear in various parts of the piston. When the engine is running, a piston ring in the piston groove tends to rotate randomly around the piston. This rotation is of no consequence in a four-stroke engine as the cylinder liner is in the form of a closed wall. In a two-stroke engine however, the rotating and reciprocating piston ring would cross several ports in the cylinder wall. As the piston ring moves across a port, it expands resiliently into the port as it crosses first edge of the port (opening edge) and then rapidly compresses again at the opposite edge (closing edge). This expansion and compression creates significant mechanical stress on the piston ring. If the gap of the piston ring happens to move across a port of the cylinder wall, the mechanical stress is especially significant at the free ends of the piston ring adjacent to its gap. It would therefore be desirable to reduce the tendency of the piston ring to rotate in order to reduce its wear.

Therefore, there is a need, particularly in two-stroke engines, for a relatively lightweight piston having good structural resistance to heat and other causes of wear.

### SUMMARY

It is an object of the present invention to ameliorate at least some of the inconveniences present in the prior art.

In one aspect, a piston for a two-stroke internal combustion engine includes a crown and a skirt extending from the crown. The skirt defines a reciprocation axis of the piston. A circumferential piston groove is defined in the crown. An annular ring carrier is disposed in the piston groove. A circumferential carrier groove is defined in the ring carrier, the carrier groove being concentric with the piston groove. A retainer is disposed in the carrier groove. The retainer extends at least in a radial direction of the piston into the ring carrier. The carrier groove is adapted to receive a piston ring and the retainer is adapted to prevent rotational motion of the piston ring in the carrier groove, the rotational motion being about the reciprocation axis.

In a further aspect, the piston comprises a pin bore adapted to receive a piston pin. A pin axis is defined by a cylindrical axis of the pin bore. The pin axis is perpendicular to the reciprocation axis of the piston. The retainer is disposed in a plane perpendicular to the pin axis and the reciprocation axis.

In an additional aspect, the retainer is a retainer pin.

In another aspect, the retainer pin is cylindrical. A cylindrical axis of the retainer pin extends in a radial direction of the piston.

In yet another aspect, the retainer is integrally formed with the ring carrier.

In a further aspect, the retainer is press fit into a retainer bore in the crown.

In an additional aspect, the piston ring is disposed in the piston ring groove. The piston ring has a gap in the circumferential direction. The retainer extends at least in part of the gap to prevent the rotational motion of the piston ring in the piston ring groove.

In a further aspect, a width of the gap in the circumferential direction is non-uniform.

In another aspect, the width of the gap in the circumferential direction is greater in a radially inward portion of the piston ring than in a radially outward portion of the piston ring.

In a further aspect, a height of the piston ring in the direction of the reciprocation axis is non-uniform.

In another aspect, the height of the piston ring is greater in a radially outward portion of the piston ring than in a radially inward portion of the piston ring.

In additional aspect, the crown and skirt are made of aluminum.

In another aspect, the ring carrier is made of steel.

In yet another aspect, the crown and skirt are made of aluminum, and the ring carrier is made of steel.

In a further aspect, the crown, skirt and ring carrier are integrally formed by casting.

In another aspect, at least one cavity extends into the skirt.

In additional aspect, the piston ring groove is a first piston ring groove, the retainer is a first retainer, and the piston ring is a first piston ring. The ring carrier further includes at least one additional circumferential piston ring groove, wherein each of the at least one additional piston ring groove is concentric with the carrier groove, spaced from the first piston ring groove in the direction of the reciprocation axis, and has a corresponding retainer disposed therein, the corresponding retainer extending at least in a radial direction of the piston into the ring carrier. Each of the at least one additional piston ring groove is adapted to receive a corresponding piston ring. The corresponding retainer is adapted to prevent rotational motion of the corresponding piston ring, the rotational motion of the corresponding piston ring being about the reciprocation axis.

In an additional aspect, the carrier groove is a first carrier groove, and the piston further comprises a second circumferential carrier groove defined in the crown. The second carrier groove is spaced from the first carrier groove in the direction of the reciprocation axis. A second annular ring carrier is disposed in the second carrier groove. A second circumferential piston ring groove is defined in the second ring carrier. The second carrier groove is concentric with the second piston ring groove. A second retainer is disposed in the second piston ring groove, the second retainer extending at least in a radial direction of the piston into the second ring carrier. The second piston ring groove is adapted to receive a second piston ring and the second retainer is adapted to prevent rotational motion of the second piston ring in the second piston ring groove, the rotational motion of the second piston ring being about the reciprocation axis.

In a further aspect, the piston ring groove is a first piston groove and the piston further comprises a second circumferential piston ring groove spaced from the first piston ring groove in the direction of the reciprocation axis. A second retainer is disposed in the second piston ring groove. The second piston ring groove is adapted to receive a second piston ring and the second retainer is adapted to prevent rotational motion of the second piston ring in the second piston ring groove, the rotational motion of the second piston ring being about the reciprocation axis. In some embodiments, the second piston ring groove is defined in the crown. In other embodiments, the second piston ring groove is defined in the ring carrier.

In another aspect, a two-stroke internal combustion engine has a cylinder, and a piston according to one or more of the above aspects, the piston being disposed in the cylinder.

In an additional aspect, the retainer of the piston is aligned in the circumferential direction with an intake port of the engine.

In a further aspect, the cylinder comprises a transfer port connected to the intake port, the transfer port being aligned with and disposed above the intake port in the direction of the reciprocation axis of the piston.

In another aspect, the transfer port has an upper edge and a lower edge, the upper and lower edges being chamfered.

In yet another aspect, the cylinder comprises an exhaust port disposed opposite the intake port in the direction perpendicular to the reciprocation axis of the piston, the exhaust port having an upper edge, the upper edge being chamfered.

In a further aspect, the engine is a direct fuel injection two-stroke engine.

Embodiments of the present invention each have at least one of the above-mentioned object and/or aspects, but do not necessarily have all of them. It should be understood that some aspects of the present invention that have resulted from attempting to attain the above-mentioned object may not satisfy this object and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a perspective view taken from a first end of an exhaust side of a direct injection, two-stroke internal combustion engine;

FIG. 2 is a side elevation view from an intake side of the engine of FIG. 1;

FIG. 3 is a top plan view of the engine of FIG. 1;

FIG. 4 is a cross-sectional view of the engine of FIG. 1 taken along the line A-A of FIG. 3;

FIG. 5 is a cross-sectional view of the engine of FIG. 1 taken along the line C-C of FIG. 3;

FIGS. 6A to 6D are various cross-sectional views of the cylinder block of FIGS. 4 and 5;

FIG. 6A is a cross-sectional view of the cylinder block of FIG. 5 respectively taken along the line A′-A′ of FIG. 5;

FIG. 6B is a cross-sectional view of the cylinder block of FIG. 5 respectively taken along the line B-B of FIG. 5;

FIG. 6C is a cross-sectional view of the cylinder block of FIG. 5 respectively taken along the line C′-C′ of FIG. 4;

FIG. 6D is a cross-sectional view of the cylinder block of FIG. 5 respectively taken along the line D-D of FIG. 4;

FIG. 7 is a planar view of the inside surface of the cylinder of FIG. 5;

FIG. 8A is a schematic top plan view of the piston of FIG. 5;

FIG. 8B is a side elevation view of the piston of FIG. 5, taken from a second end;

FIG. 8C is a cross-sectional view of the piston of FIG. 5, taken along the line F-F of FIG. 8A;

FIG. 8D is an enlarged cross-sectional view of a portion of the piston of FIG. 5 showing the piston ring and the ring carrier, taken along the line F-F of FIG. 8A; and

FIG. 8E is a cross-sectional view of the piston of FIG. 5, taken along the line G-G of FIG. 8A;

FIG. 9A is a perspective view of the piston of FIG. 5, taken from the second end of an intake side;

FIG. 9B is a perspective cross-sectional view of the piston of FIG. 9A, taken along a vertical plane to show a blind hole formed therein;

FIG. 9C is a perspective view, taken from the first end of the intake side, of the piston ring, retainer pin and a portion of the ring carrier of FIG. 9A; and

FIG. 9D is an enlarged perspective view, taken from the top, intake side, of a portion of the piston ring and retainer pin of FIG. 9A.

FIG. 10A is a top plan view of the piston ring of FIG. 9C;

FIG. 10B is an enlarged top plan view of a portion of the piston ring of FIG. 9C showing a piston ring gap; and

FIG. 10C is a cross-sectional view of the piston ring of FIG. 9C taken along the line H-H of FIG. 10A.

### DETAILED DESCRIPTION

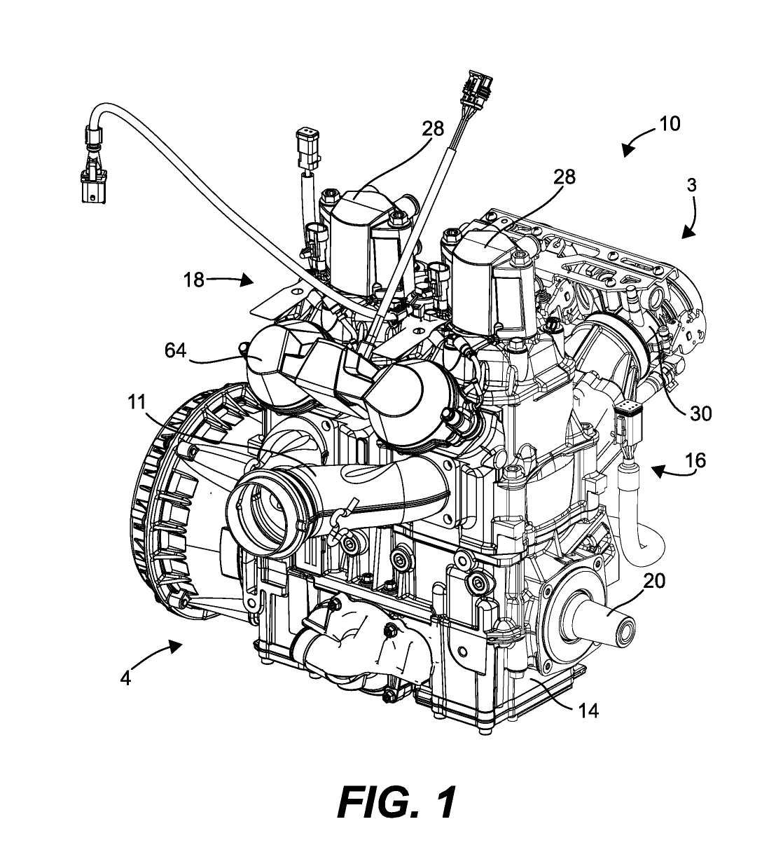

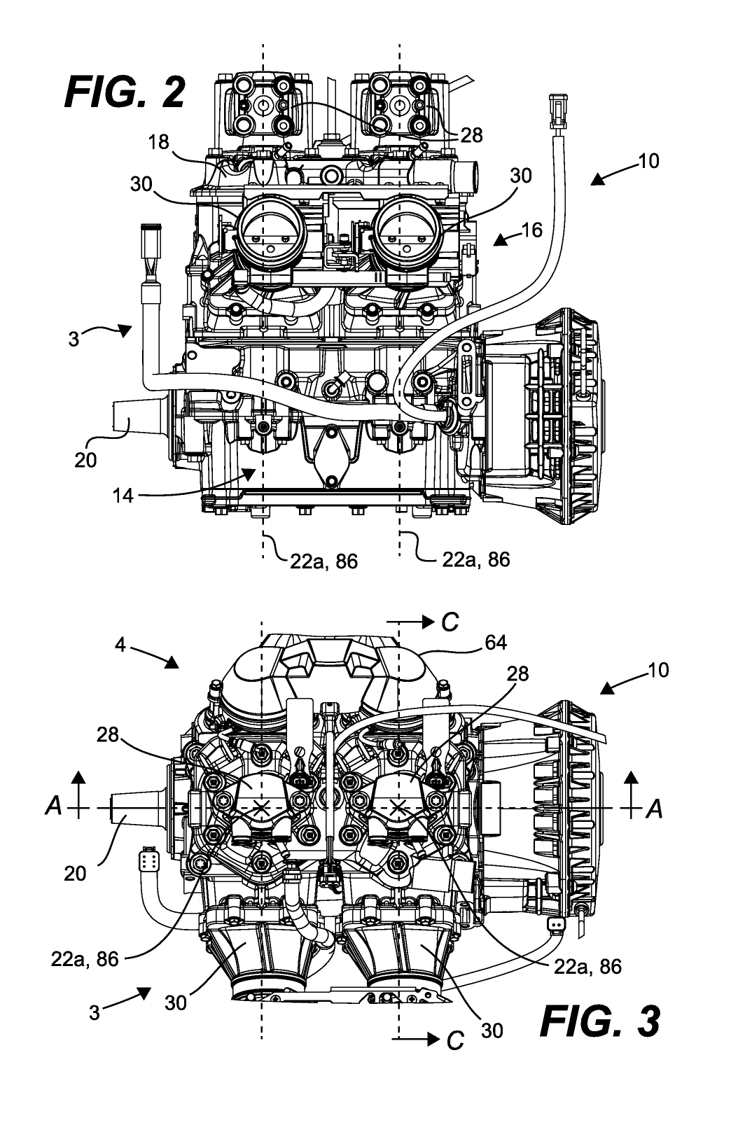

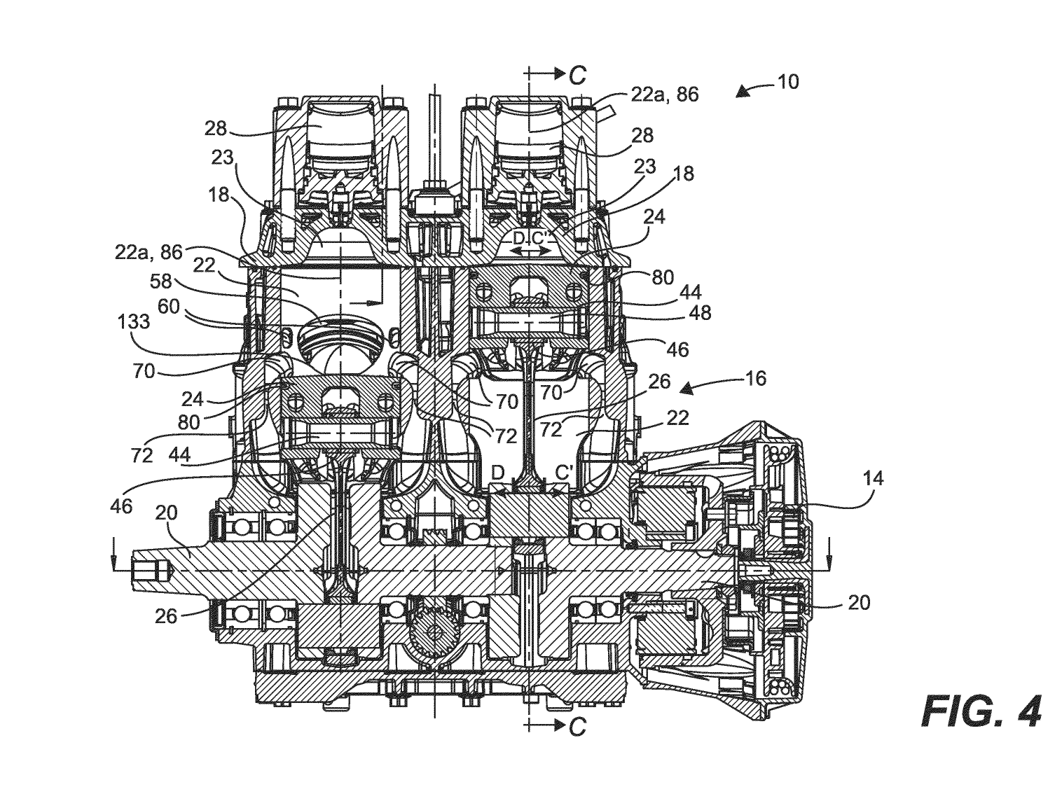

A direct injection, two-stroke, two-cylinder engine 10 will be described herein with reference to FIGS. 1 to 5. The illustrated engine 10 is a high pressure fuel injection, two-stroke, two-cylinder, 800 cc engine. It is however contemplated that aspects of the pistons described below could also be used in other types of engines, such as, but not limited to, carbureted or semi-direct injection engines and/or engines using low pressure fuel pumps.

As seen in FIGS. 1, 2 and 3, the engine 10 has a crankcase 14, a cylinder block 16, and a cylinder head 18. A crankshaft 20 is rotatably disposed inside the crankcase 14. A portion of the crankshaft 20 extends out through a wall of the crankcase 14 to be operatively connected to an element to be driven by the engine 10, such as a wheel of a motorcycle or an endless track of a snowmobile.

Two fuel injectors 28 are connected to the cylinder head 18 at the top of the engine 10 to supply fuel for the combustion process of the engine 10. The fuel injectors 28 in the illustrated embodiment of the engine 10 comprise an integrated pump and nozzle system, in which the fuel injector 28 is actuated by a solenoid and operates at injection pressures of 30 to 40 bar. It is contemplated that other kinds of fuel injectors 28 could also be used.

Two throttle bodies 30 connected to one side of the cylinder block 16 supply air to the engine 10 for the combustion process. This side of the engine 10 will be referred to herein as the intake side 3 of the engine 10. It is contemplated that the engine 10 could have only one throttle body 30. An exhaust manifold 11 (seen in FIG. 1) is connected to the opposite side of the cylinder block 16 to receive exhaust gases resulting from the combustion process occurring in the engine 10. This side of the engine 10 will be referred to herein as the exhaust side 4 of the engine 10.

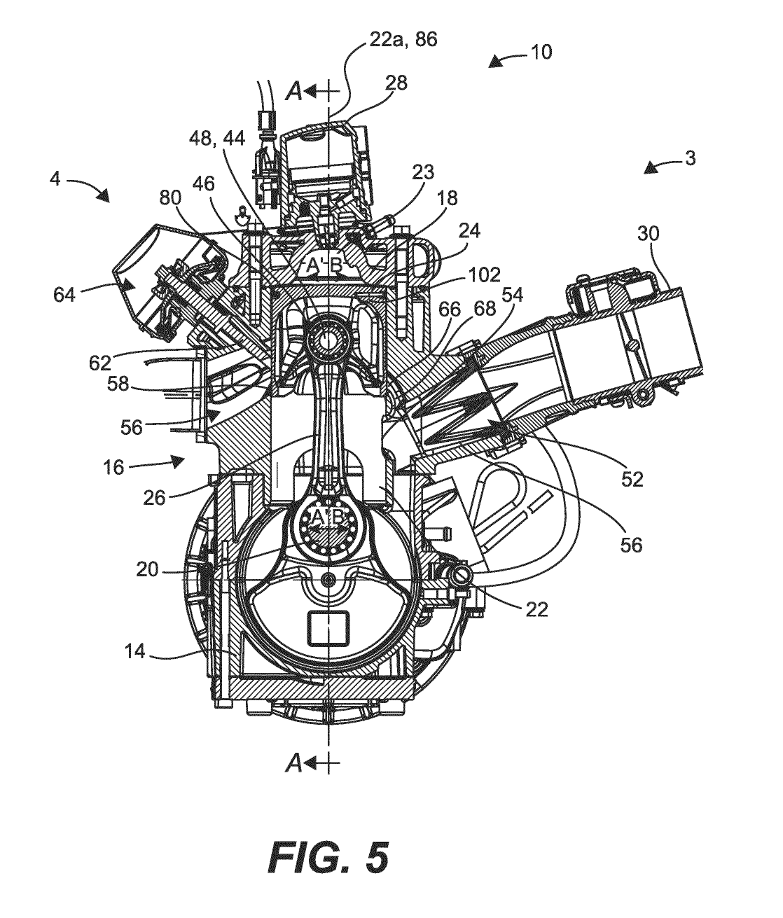

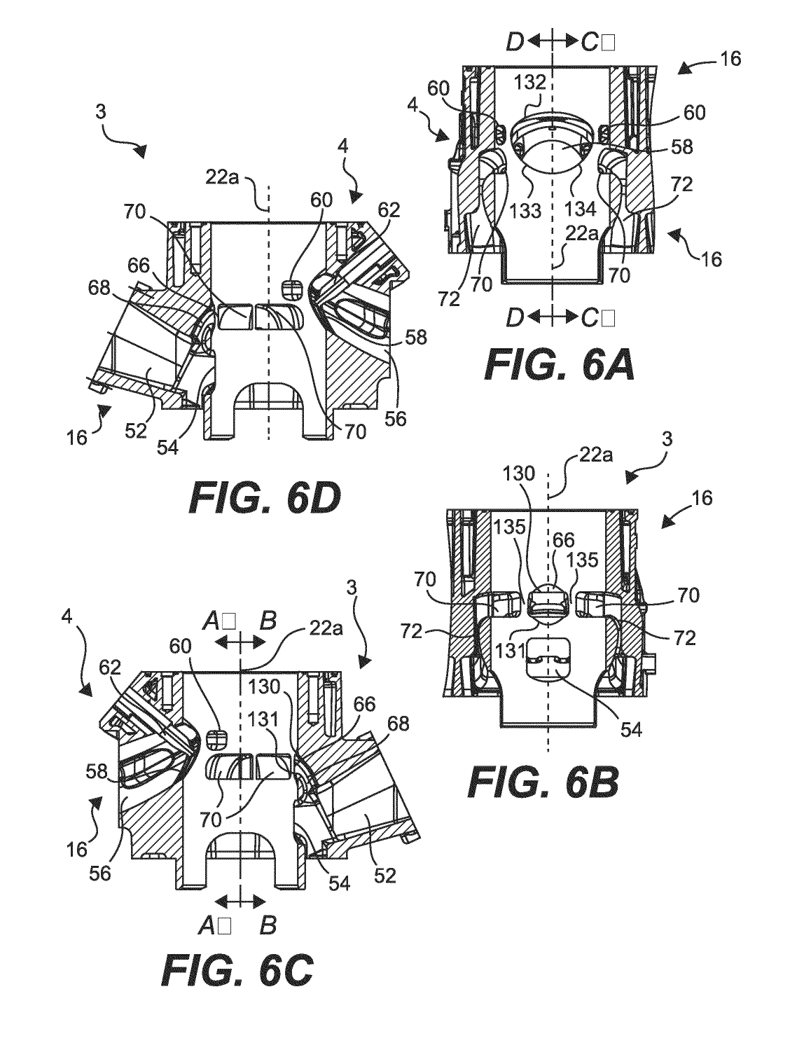

Referring to FIGS. 4 and 5, the cylinder block 16 defines two cylinders 22 disposed in line therein. A piston 24 is disposed inside each cylinder 22 to reciprocate therein. Each piston 24 is connected to the crankshaft 20 via a connecting rod 26 to drive the crankshaft 20. The piston 24 has defined therein a pair of diametrically opposite pin bores 44 (FIG. 4). The connecting rod 26 has one end received between the pin bores 44. This end of the connecting rod 26 has defined therein a rod bore 46 which is aligned coaxially with the pin bores 44. The other end of the connecting rod 26 is connected to the crankshaft 20. A piston pin 48 is inserted through the pin bores 44 and the rod bore 46 to connect the connecting rod 26 with the piston 24.

It is contemplated that the engine 10 could have one or more than two cylinders 22 with a corresponding number of pistons 24 and connecting rods 26. It is also contemplated that the cylinders 24 could have a configuration other than inline. For example, the cylinders 24 could be arranged to form a V, in which case the engine 10 would be a V-type engine. The engine 10 also has other components known to those skilled in the art, such as spark plugs, but since these are not believed to be necessary to the understanding of the present invention, they will not be described herein.

The cylinder head 18 and the piston 24 define a combustion chamber 23 in the upper portion of each cylinder 22 where the combustion process occurs. The fuel injectors 28 are connected to the combustion chambers 23 to supply fuel thereto.

With reference to FIGS. 4, 5, 6A to 6D, and 7, the cylinder 22, and various ports defined in the inside wall of the cylinder 22 will now be described in more detail.

On the intake side 3 of each cylinder 22, a throttle body 30 is connected to the cylinder 22 via an intake passage 52 and an intake port 54. The intake port 54 is located in the lower portion of the cylinder 22 on the intake side 3. Air enters from the throttle body 30, through the intake passage 52 and intake port 54, into the crankcase 14 and the lower portion of the cylinder 22. A reed valve 56 is placed in the intake passage 52 to prevent backflow of air into the throttle body 30.

On the exhaust side 4, each cylinder 22 has defined therein an exhaust port 58 with an associated exhaust passage 56, and a pair of auxiliary exhaust ports 60 with associated auxiliary exhaust passages (not shown). The two auxiliary exhaust ports 60, 60 are disposed on either side of the exhaust port 58 and aligned therewith in the vertical direction. The exhaust manifold 11 is connected to each cylinder 22 via the exhaust passages 56 and exhaust ports 58, 60. An exhaust valve passage 62 connecting to the exhaust ports 58 is also defined on the exhaust side 4 of the cylinder 22. An exhaust valve assembly 64 in the exhaust valve passage 62 is configured to change the surface areas of the exhaust port 58 and of the auxiliary exhaust ports 60 depending on the operating conditions of the engine 10. It is contemplated that the exhaust valve assembly 64, and therefore its associated exhaust valve passage 62 could be omitted. Additional details regarding the exhaust valve assembly 64 can be found in U.S. Pat. No. 7,762,220, the entirety of which is incorporated herein by reference.

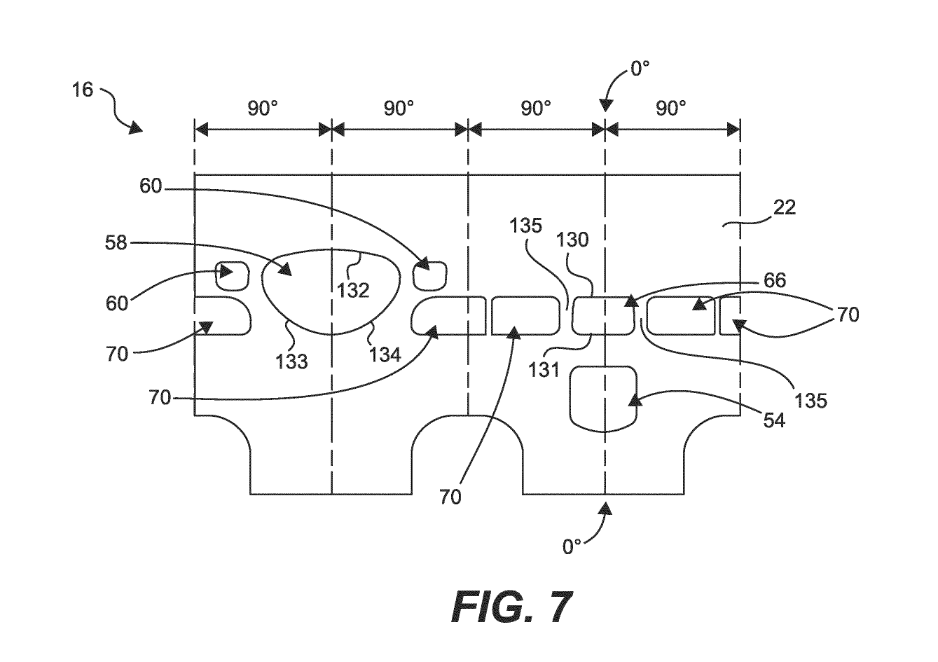

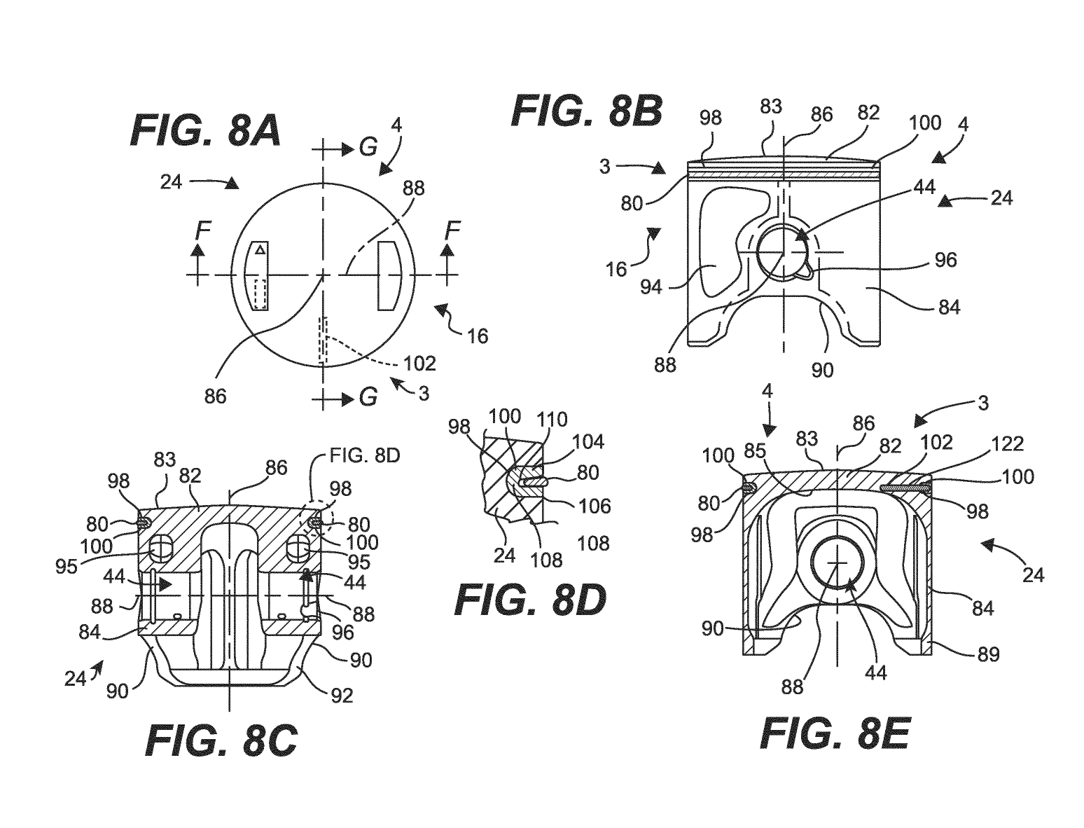

The auxiliary exhaust ports 60 are generally rectangular in shape with straight sides and rounded corners. As best seen in FIGS. 6A and 7, the exhaust port 58 has a rounded triangular shape with a curved upper edge 132, a curved lower left edge 133 and a curved lower right edge 134 and rounded corners therebetween. The lower left and right edges 133, 134 extend downward from the left and right ends respectively of the upper edge 132. The lower left and right edges 133, 134 are connected to each other below the middle of the upper edge 132. The curved edges 132, 133, 134 are connected to each other so as to form rounded corners therebetween. The width of the exhaust port 58 in the circumferential direction of the cylinder 22 is larger than its height in the axial direction of the cylinder 22. Each auxilliary exhaust port 60 is considerably smaller in area than the exhaust port 58. It is also contemplated that there could be more or less than two auxiliary exhaust ports 60. It is contemplated that the auxiliary exhaust ports 60 could be omitted. It is contemplated that the shapes and sizes of the exhaust port 58 and the auxiliary exhaust ports 60 could be different. For example, one or more edges 132, 133, 134 of the exhaust port 58 could be straight instead of curved, or the shape of the exhaust port 58 could be rectangular or oval instead of triangular.

A central transfer port 66 and associated passage 68, and side transfer ports 70 along with their associated passages 72, are also defined on the intake side 3 of the cylinder 22 above the intake port 54. The passages 68, 72 are connected to the intake port 54. Air in the crankcase 14 and the lower portion of the cylinder 22 thus enters the combustion chamber 23 through the side and central transfer ports 66, 70.

As best seen in FIG. 7, the central transfer port 66 is aligned vertically with the intake port 54. The side transfer ports 70 are disposed symmetrically on either side of the central transfer port 66 and aligned with it in the vertical direction. The side and central transfer ports 70, 66 are generally rectangular in shape and smaller than the generally rectangular intake port 54. It is contemplated that the transfer ports 66, 70 could be configured differently, for example, the shape, size and number of transfer ports 66, 70 could be different than as shown. It is also contemplated that the shapes and size of the intake port 54 could be different.

As the piston 24 reciprocates in the cylinder 22, it opens and closes the central and side transfer ports 66, 70, the intake port 54, the exhaust port 58, and the pair of auxiliary exhaust ports 60, in a manner commonly known in two-stroke internal combustion engines.

When the piston 24 is disposed in the upper portion of the cylinder 22, as seen in the right side cylinder 22 of FIG. 4 and in FIG. 5, the intake port 54 is open, and the transfer ports 66, 70 and exhaust ports 58, 60 are closed. When the piston 24 is in the lower portion of the cylinder 22, as can be seen in the left side cylinder 22 of FIG. 4, the exhaust ports 58, 60 and transfer ports 66, 70 are open, and the intake port 54 is closed. The open exhaust ports 58, 60 can be seen in the left side cylinder 22 of FIG. 4 where the piston 24 is in the lowered position.

A piston ring 80 arranged around each piston 24, as will be described in greater detail below, helps prevent gases present in the combustion chamber 23 from entering the lower portion of the cylinder 22 and the chamber defined by the crankcase 14.

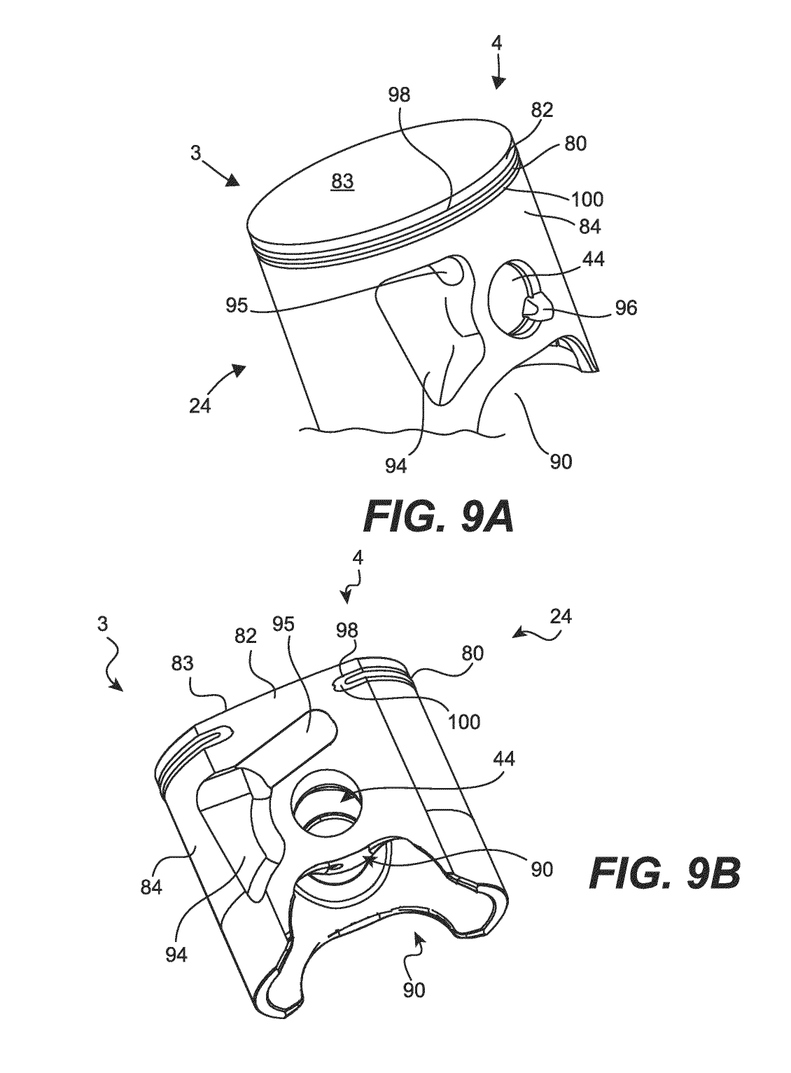

Turning now to FIGS. 8A to 10C, one of the pistons 24 will be described in more detail. The other one of the pistons 24 is the same and will therefore not be described herein.

The piston 24 has a crown 82 and a generally cylindrical skirt 84 extending therefrom. A central axis 86 of the skirt 84 defines a reciprocation axis 86 of the piston 24. As the name suggests, the reciprocation axis 86 is the axis along which the piston 24 reciprocates in the cylinder 22 and is coaxial with a central axis 22a of the cylinder 22.

As mentioned above, the piston 24 has two pin bores 44 defined in the skirt. The pin bores 44 are diametrically opposite to one another and define a pin bore axis 88 which is perpendicular to the reciprocation axis 86. A notch 96 is formed on the circumference of the pin bore 44 to receive a hook of a retaining ring (not shown) inserted around the axis of the pin 48 to prevent motion of the pin 48 in the axial direction (i.e. in the direction of the pin bore axis 88).

The crown 82 has an outer surface 83 and an inner surface 85. As can be seen in FIG. 8E, the outer surface 83 of the crown 82 is a convex conical surface. It is contemplated that the outer surface 83 could have other shapes, such as, for example, flat, and concave, and could be provided with one or more protrusions and/or recesses.

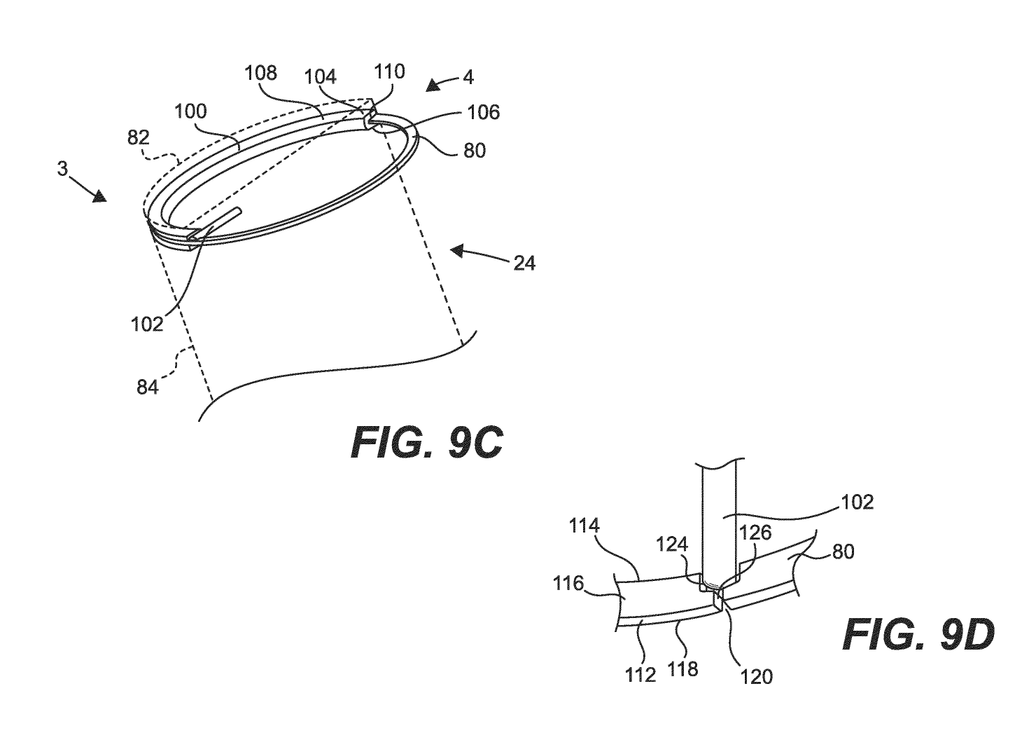

As best seen in FIGS. 8B, 8E and 9A, the skirt 84 defines two arches 90 at a free end 89 thereof (i.e. the end not connected to the crown 66). The arches 90 are disposed on opposite sides of the reciprocation axis 86. The arches 90 have flat tops, but could have other shapes.

As can be seen in FIGS. 8B, 9A and 9B, the piston 24 has a cavity 94 extending into the piston body near each one of the pin bores. The cavities 94 could have any other shape, or there could be more or less than two cavities 94 formed in the piston skirt 84. The cavities 94 and the arches 90 help reduce the weight of the piston 24. It is contemplated that the cavities 94 and/or the arches 90 could be omitted.

With reference to FIGS. 8C, 9A and 9B, a blind hole 95 extends from each cavity 94 into the piston body. The blind holes 95 extend generally horizontally (transverse to the reciprocation axis 86 and transverse to the pin bore axis 88). The blind holes 95 are positioned vertically between the piston crown 82 and the pin bore 44. The blind holes 95 are generally cylindrical and created by drilling into the cavities 94. It is contemplated that the blind holes 95 could be created in the casting process during the formation of the piston body. The blind holes 95 help to reduce heat conduction from the piston crown 82 to the pin bores 44, and to further reduce the weight of the piston 24, without weakening the stability of the piston 24. It is contemplated that the blind holes 95 could be in a position other than adjacent to the cavities 94. It is contemplated that the blind holes 95 could have a different shape, or that there could be more or less than two blind holes 95. It is also contemplated that the blind holes 95 could be omitted.

A piston groove 98 is defined on an outer circumference of the crown 82. The circumferential piston groove 98 extends inwards from the outer surface of the piston 24 into the piston body. A ring carrier 100, the piston ring 80 and a retainer pin 102 are received in the piston groove 98.

The circumferential ring carrier 100 extends radially inwards from the outer surface of the piston 24 into the piston groove 98. The ring carrier 100 and the piston groove 98 have a complementary cross-section in the radial direction of the piston 24 so that the ring carrier 100 fits tightly within the piston groove 98.

As best seen in FIGS. 8D, 9B and 9C, the ring carrier 100 has a U-shaped cross-section with an upper portion 104, a lower portion 106, an inner portion 108 and a carrier groove 110. The upper and lower portions 104, 106 and the carrier groove 110 extend radially inwards from the outer surface of the piston 24 into the piston groove 98. The upper and lower portions 104, 106 extend respectively above and below the carrier groove 110. The inner portion 108 connects the upper and lower portions 104, 106.

The lower surface (adjacent to the lower portion 106) of the carrier groove 110 extends generally horizontally while the upper surface (adjacent to the upper portion 104) slopes upwards and outwards. It is contemplated that both the upper and lower surfaces could extend horizontally. It is also contemplated that one or both of the upper and lower surfaces of the carrier groove 110 could be contoured or inclined with respect to the horizontal direction.

A piston ring 80 is received in the circumferential carrier groove 110 of the ring carrier 100. The piston ring 80 contacts the inside wall of the cylinder 22 around the piston groove 98 and helps to seal the combustion chamber 23, thereby maintaining pressure inside the combustion chamber 23 and preventing blow-by of fluids from the combustion chamber 23 into the crankcase 14 or the portion of the cylinder 22 below the piston ring 80. The piston ring 80 also serves to transfer heat from the piston 24 to the cylinder 22.

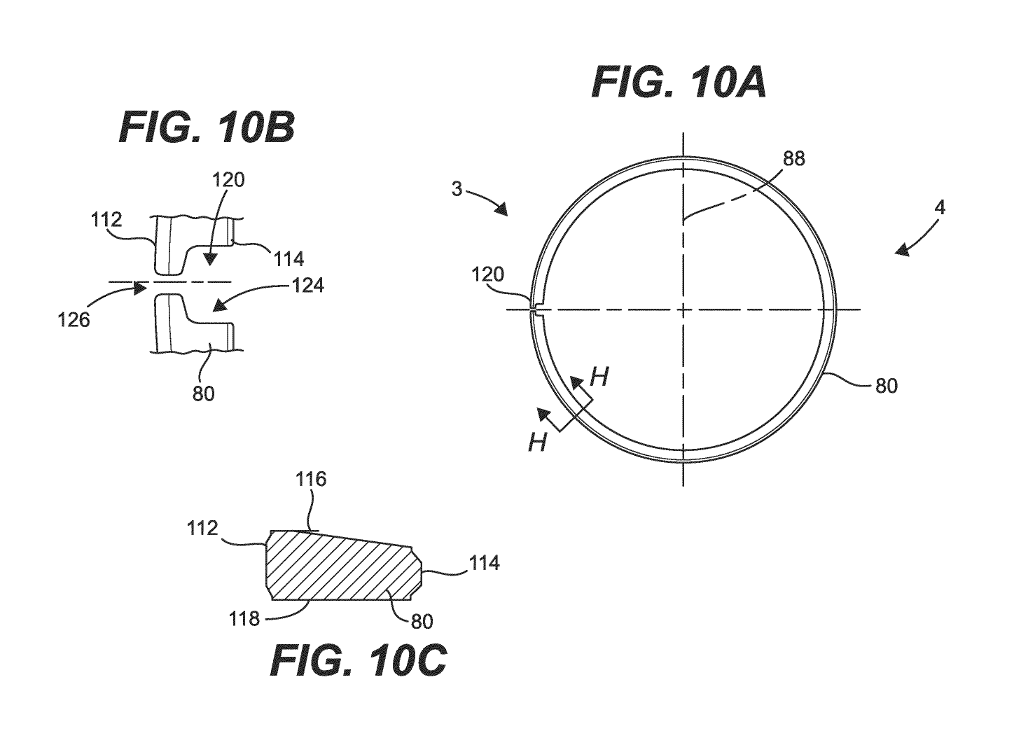

With reference to FIG. 10C, the piston ring 80 has a generally trapezoidal cross-section. The piston ring has an outer surface 112 and an inner surface 114 respectively disposed at a radially outward and a radially inward position with respect to the piston 24. The piston ring 80 has an upper 116 and a lower surface 118 extending between the outer and inner surfaces 112, 114. The height of the piston ring 80 (separation between the upper and lower surfaces 116, 118) decreases from the outer surface 112 towards the inner surface 114. The outer surface 112 curves radially inwards at the upper and lower surfaces 116, 118. The inner surface 114 is generally vertical in the central portion, and has inclined portions adjacent to the upper and lower surfaces 116, 118. It is also contemplated that the cross-section could have other shapes, for example, circular. It will be understood that the carrier groove 110 and the piston ring 80 are generally complementary in cross-section.

The piston ring 80 is discontinuous in the circumferential direction, having a gap 120 extending between the inner and outer surfaces 112, 114. The gap 120 enables installation of the piston ring 80 around the piston 24. The gap 120 also enables a proper fit between the piston ring 80 and the cylinder 22 at different temperatures by allowing room for piston ring 80 to expand into the gap 120. In the absence of the gap 120, expansion of the piston ring 80 could lead to its distortion, bending and/or buckling, also potentially resulting in an improper seal between the piston ring and the cylinder wall.

The retainer pin 102 projects radially outward from the piston crown 82 into the carrier groove 110 and the piston ring gap 120. The retainer pin 102 prevents the piston ring 80 from rotating. In the illustrated embodiment, the retainer pin 102 is a cylindrical rod inserted into a retainer pin bore 122 (FIG. 8E) drilled through the ring carrier 100 into the piston crown 82. The outer end of the retainer pin 102 projecting into the carrier groove 110 is rounded and convex in the radially outwardly direction. It is also contemplated that the retainer pin 102 could be shaped differently, for example, the end projecting into the carrier groove 110 could be conical or flat. In some alternate embodiments, the retainer pin 102 is a projection of the ring carrier 100 projecting into its carrier groove 110, and integrally formed with the ring carrier 100. The diameter of the retainer pin 102 is larger than the height of the piston ring 80. It is however also contemplated that the height of the piston ring 80 could be the same or greater than the diameter of the retainer pin 102.

The gap 120 has a width, measured in the circumferential direction. The width of the gap is non-uniform between the inner and outer surfaces 112, 114, i.e. in the radial direction. The gap 120 has a radially inward section 124 adjacent the inner surface 114, and a radially outward section 126 near the outer surface 112 of the piston ring 80. The radially inward section 124 has a wider gap 120, adapted to receive the retainer pin 102, than the gap 120 in the radially outward section 126. The width of the gap is constant in the radially inward and radially outward sections. The width of the gap does not vary in the vertical direction, i.e. the surfaces of the piston ring 80 adjacent to the gap 120 extend vertically. It is contemplated that the walls of the piston ring 80 defining the gap 120 could be other than vertical, for example, if the thickness of the piston ring 80 (i.e. separation between the upper and lower surfaces 116, 118) is larger than the diameter of the retainer pin 102, the walls defining the gap 120 could be contoured to properly fit the retainer pin 102 received therein.

The narrower gap 120 of the radially outward section 126 serves to improve the sealing between the cylinder 22 and the piston ring 80 (in the vicinity of the gap 120) by minimizing the gap 120 through which fluid can communicate between the combustion chamber 23 and the portion of the cylinder 22 below the piston ring 80.

The narrower gap 120 of the radially outward section 126 can aid in preventing the retainer pin 102 from sliding outwards from the ring carrier 100 and/or piston crown 82, for example, in the case where the retainer pin 102 is press-fit into the piston crown 82. If the piston 24 and the retainer pin 102 are made of different materials, their different rates of expansion and contraction could result in the press-fit retainer pin 102 becoming loose. Since the gap width is narrower than the retainer pin diameter, the loosened retainer pin 102 is prevented from sliding outwards. The retainer pin 102 and piston ring 80 are thereby retained in their respective positions by their mutual engagement.

It is contemplated that the gap width could be the same in the radially inward and outward sections 124, 126 of the piston ring 80. It is also contemplated that the width of the gap 120 could decrease continuously between the inner and outer surfaces 112, 114 (for example, for a retainer pin 80 having a V-shaped end), or that the gap 120 could have any other shape configured to receive the free end of the retainer pin 102 projecting out into the carrier groove 110.

Turning now to FIGS. 4 to 7, the position of the piston ring 80 and the retainer pin 102 in the piston 24 with respect to the cylinder 22 will now be discussed in more detail.

The retainer pin 102 (and therefore the piston ring gap 120) is positioned in alignment with the center of the intake port 54 and the central transfer port 66, which is hereby defined as 0° with respect to the cylinder 22. FIG. 5 shows the retainer pin 102 positioned directly above the central transfer port 66 and the intake port 54 with the piston 24 disposed at the highest point of its reciprocating motion. When the piston 24 moves to the lowest point of its reciprocating motion (not shown), the ring gap 120 and the retainer pin 102 are disposed below the central transfer port 66 and above the intake port 54. Thus, the reciprocating motion of the piston 24 in the cylinder 22 causes the ring gap 120 to move down the inside wall of the cylinder 22, past the upper edge 130 and lower edge 131 (FIGS. 6B and 7) of the central transfer port 66. The pin 102 and gap 120, however, do not cross the intake port 54 in the illustrated embodiment of cylinder 22 and piston 24.

As can be seen in FIG. 6B, the central transfer port 66 is broadly chamfered at its upper and lower edges 130, 131 to enable a gradual or soft compression and expansion of the piston ring 80 as it crosses downwards and upwards past the edges 130, 131. The upper edge 132 of the exhaust port 58 is also broadly chamfered, as best seen in FIG. 6A, to prevent sudden compression or expansion of the piston ring 80, specifically the portion of the piston ring 80 opposite the ring gap 120, as it moves upwards or downwards past the upper edge 132 of the exhaust port 58.

The ends of piston ring 80 adjacent the gap 120 are subjected to expansion and compression as the gap 120 moves past the upper edge 130 and the lower edge 131 of the central transfer port 66 as described above. It has however been observed that the piston ring 80 has a reduced tendency to rotate when disposed with the gap 120 in this 0° position when compared, for example, to a position where the gap 120 is in alignment with the bridge 135 between central 66 and side transfer ports 70 (at 25° counter-clockwise with respect to the intake port 54), where the gap 120 does not cross any ports during the reciprocating motion of the piston 24 in the cylinder 22.

It is contemplated that the piston 24 could have more than one piston groove 98. It is contemplated that the additional piston grooves 98 could have piston rings 80 disposed directly therein. It is also contemplated that the some or all of the additional piston grooves 98 could each have a ring carrier 100 with a piston ring 80 disposed therein. It is further contemplated that the piston 24 could have a ring carrier 100 with multiple carrier grooves 110, each carrier groove 110 having disposed therein a piston ring 80.

In the illustrated embodiment, the ring carrier 100 and the retainer pin 102 are made of hardened steel. The piston skirt 84 and crown 82 are made of aluminum. It is however contemplated that the retainer pin 102 and/or ring carrier 100 could also be made of any other suitable material, such as for example, stainless steel. It is contemplated that the retainer pin 102 and the ring carrier 100 could be made of different materials or the same material.

The crown 82, the skirt 84 and the ring carrier 100 are integrally formed by a metal casting process. The ring carrier 100 is first produced by a process of centrifugal casting. The ring carrier 100 is pre-machined and then coated with aluminum by immersing it in a molten aluminum bath to facilitate bonding with the aluminum piston crown 82. The aluminum piston crown 82 and skirt 84 are cast from molten aluminum by a gravity casting process. The ring carrier 100 is placed in the mold while the piston 24 is being cast so that the piston 24 is formed with a piston groove 98 and the ring carrier 100 being received in the piston groove 98. The integrally formed piston 24 and ring carrier 100 are then subjected to heat treatment for hardening of the materials, for relieving stress in the formed structures, and/or other such objectives. The carrier groove 110 is machined into the steel ring carrier 100. The piston 24 and integrated ring carrier 100 are then anodized to create a corrosion proof surface. The retainer pin bore 122 is drilled into the ring carrier 100 and the piston crown 82 for receiving the retainer pin 102. The retainer pin 102 is then pressed into the retainer pin bore 122 and held therein by friction.

In an alternate embodiment of the piston 24 where the retainer pin 102 is a projection of the ring carrier 100 integrally formed with the ring carrier 100, the ring carrier 100 is formed by an initial casting process without a carrier groove 110 or with a carrier groove 110 of reduced depth as compared to the final shape shown in FIGS. 8C to 8E. The ring carrier 100 is then placed in the mold during casting of the aluminum piston 24. After casting of the piston 24 the carrier groove 110 is machined in the ring carrier 100 by milling in such a way that a retainer pin 102 remains as a projection of the ring carrier 100 in the carrier groove 110, to create a piston 24 having a piston groove 98 with a ring carrier 100 and retainer pin 102 received therein.

The piston ring 80 is installed in the carrier groove 110 so that the gap 120 of the piston ring 80 fits over the retainer pin 102. A pair of piston ring pliers, a piston ring compressor or other such tools may be used to facilitate installation of the piston ring 80 on the piston 24.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. A two-stroke internal combustion engine comprising:
a cylinder having an intake port; and
a piston disposed in the cylinder, the piston comprising:
a crown;
a skirt extending from the crown, the skirt defining a reciprocation axis of the piston;
a circumferential piston groove defined in the crown;
an annular ring carrier disposed in the piston groove;
a circumferential carrier groove defined in the ring carrier, the carrier groove being concentric with the piston groove;
a retainer disposed in the carrier groove, the retainer extending at least in a radial direction of the piston into the ring carrier, the retainer being aligned with the intake port in a circumferential direction of the piston; and
a piston ring disposed in the carrier groove, the piston ring having a gap in the circumferential direction, the retainer extending at least in part of the gap to prevent rotational motion of the piston ring in the carrier groove, the rotational motion being about the reciprocation axis.

2. The engine of claim 1, further comprising a pin bore adapted to receive a piston pin, a pin axis being defined by a cylindrical axis of the pin bore, the pin axis being perpendicular to the reciprocation axis of the piston;
wherein the retainer is disposed in a plane perpendicular to the pin axis and the reciprocation axis.

3. The engine of claim 1, wherein the retainer is a retainer pin.

4. The engine of claim 3, wherein the retainer pin is cylindrical, a cylindrical axis of the retainer pin extending in a radial direction of the piston.

5. The engine of claim 1, wherein the retainer is integrally formed with the ring carrier.

6. The engine of claim 1, wherein the retainer is press fit into a retainer bore in the crown.

7. The engine of claim 1, wherein a height of the piston ring in the direction of the reciprocation axis is non-uniform.

8. The engine of claim 7, wherein the height of the piston ring is greater in a radially outward portion of the piston ring than in a radially inward portion of the piston ring.

9. The engine of claim 1, wherein the crown and skirt are made of aluminium.

10. The engine of claim 9, wherein the ring carrier is made of steel.

11. The engine of claim 1, wherein the ring carrier is made of steel.

12. The engine of claim 1, wherein the crown, skirt and ring carrier are integrally formed by casting.

13. The engine of claim 1, wherein at least one cavity extends into the skirt.

14. The engine of claim 1, wherein
the carrier groove is a first carrier groove,
the retainer is a first retainer, and
the piston ring is a first piston ring,
the ring carrier further comprising:
at least one additional circumferential carrier groove, wherein each of the at least one additional carrier groove:
is concentric with the piston groove,
is spaced from the first carrier groove in the direction of the reciprocation axis,
has a corresponding retainer disposed therein, the corresponding retainer extending at least in a radial direction of the piston into the ring carrier, and
is adapted to receive a corresponding piston ring, the corresponding retainer being adapted to prevent rotational motion of the corresponding piston ring, the rotational motion of the corresponding piston ring being about the reciprocation axis.

15. The engine of claim 1, wherein the piston groove is a first piston groove, the piston further comprising:
a second circumferential piston groove defined in the crown, the second piston groove being spaced from the first piston groove in the direction of the reciprocation axis;
a second annular ring carrier disposed in the second piston groove;
a second circumferential carrier groove defined in the second ring carrier, the second piston groove being concentric with the second carrier groove; and
a second retainer disposed in the second carrier groove, the second retainer extending at least in a radial direction of the piston into the ring carrier;
the second carrier groove being adapted to receive a second piston ring and the second retainer being adapted to prevent rotational motion of the second piston ring in the second carrier groove, the rotational motion of the second piston ring being about the reciprocation axis.

16. The engine of claim 1, wherein the carrier groove is a first carrier groove, the piston further comprising:
a second circumferential carrier groove, the second carrier groove being spaced from the first carrier groove in the direction of the reciprocation axis; and
a second retainer disposed in the second carrier groove;
the second carrier groove being adapted to receive a second piston ring and the second retainer being adapted to prevent rotational motion of the second piston ring in the second carrier groove, the rotational motion of the second piston ring being about the reciprocation axis.

17. The engine of claim 16, wherein the second carrier groove is defined in the Crown.

18. The engine of claim 16, wherein the second carrier groove is defined in the ring carrier.

19. The engine of any one of claims 1 to 18, wherein the cylinder comprises a transfer port connected to the intake port, the transfer port being aligned with and disposed above the intake port in the direction of the reciprocation axis of the piston.

20. The engine of claim 19, wherein the transfer port has an upper edge and a lower edge, the upper and lower edges being chamfered.

21. The engine of any one of claims 1 to 20, wherein the cylinder comprises an exhaust port disposed opposite the intake port in the direction perpendicular to the reciprocation axis of the piston, the exhaust port having an upper edge, the upper edge being chamfered.

22. The engine of any one of claim 1, wherein the engine is a direct fuel injection two-stroke engine.

23. The engine of claim 1, wherein the width of the gap in the circumferential direction is non-uniform.

24. The engine of claim 23, wherein the width of the gap in the circumferential direction is greater in a radially inward portion of the piston ring than in a radially outward portion of the piston ring.

25. A piston for a two-stroke internal combustion engine comprising:
a crown;
a skirt extending from the crown, the skirt defining a reciprocation axis of the piston;
a pair of diametrically opposed pin bores defined in the skirt and defining a pin bore axis extending perpendicular to the reciprocation axis;
a circumferential piston groove defined in the crown;
an annular ring carrier disposed in the piston groove;
a circumferential carrier groove defined in the ring carrier, the carrier groove being concentric with the piston groove; and
a retainer disposed in the carrier groove in an intake side of the piston adapted to be disposed in an intake side of a cylinder of the engine, the retainer extending at least in a radial direction of the piston into the ring carrier,
in a circumferential direction, the retainer being disposed farther from a plane containing the reciprocation axis and the pin bore axis than from a plane containing the reciprocation axis and being normal to the pin bore axis,
the carrier groove being adapted to receive a piston ring and the retainer being adapted to extend at least in part in a circumferential gap of the piston ring to prevent rotational motion of the piston ring in the carrier groove, the rotational motion being about the reciprocation axis.

26. The piston of claim 25, further comprising the piston ring disposed in the carrier groove, the piston ring having the circumferential gap and the retainer being disposed at least in part in the circumferential gap.

27. A two-stroke internal combustion engine comprising:
a cylinder; and
a piston according to any one of claims 25 and 26 disposed in the cylinder.
